(19) United States
(12) Patent Application Publication
(10) Pub. No.: US 2022/0256097 A1
(43) Pub. Date: Aug. 11, 2022

(54) METHOD, SYSTEM AND APPARATUS FOR IMPLEMENTING OMNIDIRECTIONAL VISION OBSTACLE AVOIDANCE AND STORAGE MEDIUM

(71) Applicant: AUTEL ROBOTICS CO., LTD., Shenzhen (CN)

(72) Inventor: Zhaozao LI, Shenzhen (CN)

(21) Appl. No.: 17/660,504

(22) Filed: Apr. 25, 2022

Related U.S. Application Data
(63) Continuation of application No. PCT/CN2020/123317, filed on Oct. 23, 2020.

(30) Foreign Application Priority Data
Oct. 25, 2019 (CN) 201911024682.9

(51) Int. Cl. H04N 5/265; H04N 7/18

(52) U.S. Cl. CPC H04N 5/265; H04N 7/181

(57) ABSTRACT

The embodiments are a method, a system and an apparatus for implementing an omnidirectional vision obstacle avoidance, and a storage medium. The method for implementing an omnidirectional vision obstacle avoidance includes: transmitting a trigger signal to an image capture device, to trigger the image capture device to capture image signals; combining the image signals to obtain combined image data; disassembling the combined image data to obtain disassembled image data; and visually processing the disassembled image data to acquire a visual image. Based on the technical solutions in the present invention, a multi-lens access problem of existing aircrafts during omnidirectional vision obstacle avoidance is resolved and image processing efficiency and performance are improved.

### CROSS-REFERENCE TO RELATED APPLICATIONS

The present application is a continuation of the International Application No. PCT/CN2020/123317, filed on Oct. 23, 2020, which claims priority of Chinese patent No. 201911024682.9, filed on Oct. 25, 2019, both of which are hereby incorporated by reference in their entireties.

### BACKGROUND

### Technical Field

Embodiments of the present invention relate to the field of aircrafts, and in particular, to a method, a system and an apparatus for implementing an omnidirectional vision obstacle avoidance, and a storage medium.

### Related Art

With a development of aircraft technologies, obstacle avoidance of aircrafts has been required to support omnidirectional obstacle avoidance in six directions, namely, front, lower, rear, left, right and upper directions. Since coordinates of the same object in pictures from two lenses are slightly different, a distance between the aircraft and the obstacle may be obtained through conversion. Based on this, a binocular vision method may alternatively be adopted to capture a depth image of the obstacle. Therefore, at least a total of 13 lenses including a primary lens and 6 pairs of lenses, namely, 12 lenses are required to achieve an omnidirectional vision obstacle avoidance. However, existing main chips on the market support input from at most 8 lenses, which is far below requirements of the omnidirectional obstacle avoidance. In addition, image processing on captured image signals becomes a bottleneck on existing image signal processors (ISPs) and main chips. When a large amount of image information needs to be synchronously processed, a single chip cannot meet a performance requirement of synchronously processing the large amount of image information. Further, high real-time performance and a high processing speed are required for obstacle avoidance of the aircrafts. However, such requirements cannot be met in existing technologies. In the existing technologies, image signals captured by a plurality of lenses of the aircraft cannot be quickly processed in a timely manner, and processing efficiency and performance are insufficient.

### SUMMARY

An objective of the present invention is to provide a method, a system and an apparatus for implementing an omnidirectional vision obstacle avoidance, and a storage medium, to resolve problems of multi-lens access, mage processing efficiency and performance of existing aircrafts during omnidirectional vision obstacle avoidance.

To achieve the above objective, the present invention provides a method for implementing an omnidirectional vision obstacle avoidance, including:

S10: transmitting a trigger signal to an image capture device, to trigger the image capture device to capture image signals;

S20: combining the image signals to obtain combined image data;

S30: disassembling the combined image data to obtain disassembled image data; and

S40: visually processing the disassembled image data to acquire a visual image.

Further, the trigger signal is transmitted to the image capture device by using a synchronization trigger clock. Furthermore, the trigger signal is a pulse signal.

Further, in S20, the image signals are combined by using an image signal processor (ISP) to obtain the combined image data.

Further, the disassembling in S30 includes:

sequentially copying the combined image data according to an image line number, to obtain the disassembled image data; or

disassembling the combined image data according to a start address offset and a width and a stride of a combined image, to obtain the disassembled image data.

In addition, the present invention further provides an omnidirectional vision obstacle avoidance implementation system, including:

a synchronization trigger clock, configured to transmit a trigger signal to an image capture device, to trigger the image capture device to capture image signals;

a plurality of ISPs and a main chip, configured to combine the image signals to obtain combined image data; and

a main chip, configured to disassemble the combined image data and visually process the disassembled image data, to acquire a visual image.

Further, the trigger signal is a pulse signal.

Further, the step of disassembling performed by the main chip includes:

sequentially copying the combined image data according to an image line number, to obtain the disassembled image data; or

disassembling the combined image data according to a start address offset and a width and a stride of a combined image, to obtain the disassembled image data.

To achieve the above objective, the present invention further provides an apparatus for implementing an omnidirectional vision obstacle avoidance, including a memory and a processor, the memory storing a program for omnidirectional vision obstacle avoidance executable on the processor, the program for omnidirectional vision obstacle avoidance, when executed by the processor, performing the above method for implementing an omnidirectional vision obstacle avoidance.

In addition, to achieve the above objective, the present invention further provides a computer-readable storage medium storing a program for omnidirectional vision obstacle avoidance, the program for omnidirectional vision obstacle avoidance being executable by one or more processors to perform the above method for implementing an omnidirectional vision obstacle avoidance.

Based on the method and the apparatus for implementing an omnidirectional vision obstacle avoidance and and the computer-readable storage medium in the present invention, the problems of multi-lens access and insufficient image processing performance of the aircrafts during the omnidirectional vision obstacle avoidance in the existing technologies are resolved, thereby implementing omnidirectional vision obstacle avoidance for the aircrafts.

### BRIEF DESCRIPTION OF THE DRAWINGS

FIG. 1 is a schematic flowchart of a method for implementing an omnidirectional vision obstacle avoidance according to an embodiment of the present invention.

FIG. 2 is a schematic diagram of a system for implementing an omnidirectional vision obstacle avoidance according to an embodiment of the present invention.

FIG. 3 is a schematic diagram of transmitting a trigger signal by a synchronization trigger clock according to an embodiment of the present invention.

FIG. 4 is a schematic diagram of combining two paths of image signals into one path of image signal according to an embodiment of the present invention.

FIG. 5 is a schematic diagram of recombination after two paths of image signals in four paths of image signals are combined into one path of image signal and two other paths of image signals in four paths of image signals are combined into the other path of image signal according to an embodiment of the present invention.

FIG. 6 is a schematic diagram of directly combining four paths of image signals into one path of image signal according to an embodiment of the present invention.

FIG. 7 is a schematic diagram of a first method for disassembling image data according to an embodiment of the present invention.

FIG. 8 is a schematic diagram of a second method for disassembling image data according to an embodiment of the present invention.

FIG. 9 is a schematic diagram of an internal structure of an apparatus for implementing an omnidirectional vision obstacle avoidance according to an embodiment of the present invention.

FIG. 10 is a schematic diagram of modules of a program for an omnidirectional vision obstacle avoidance in an apparatus for implementing an omnidirectional vision obstacle avoidance according to an embodiment of the present invention.

### DETAILED DESCRIPTION

To make objectives, technical solutions and advantages of the present invention clearer and more comprehensible, the following further describes the present invention in detail with reference to accompanying drawings and embodiments. It should be understood that the embodiments described herein are provided for illustrating the present invention and not intended to limit the present invention. All other embodiments obtained by a person of ordinary skill in the art based on the embodiments of the present invention without creative efforts shall fall within the protection scope of the present invention.

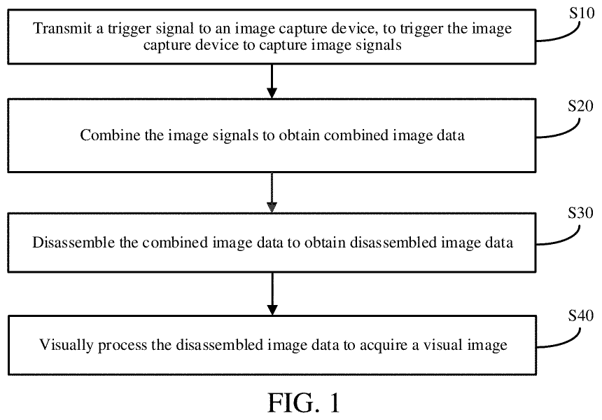

FIG. 1 is a schematic flowchart of a method for implementing an omnidirectional vision obstacle avoidance according to an embodiment of the present invention. The method for implementing an omnidirectional vision obstacle avoidance in the present invention is applicable to an aircraft and includes the following steps.

In S10, a trigger signal is transmitted to an image capture device, to trigger the image capture device to capture image signals. Specifically, the trigger signal is transmitted to the image capture device by using a synchronization trigger clock. Furthermore, the trigger signal is a pulse signal. In an embodiment, the image capture device is lenses of the aircraft. The image capture device may capture image signals after receiving the trigger signal.

In S20, the image signals are combined to obtain combined image data. Specifically, the image signals are combined by using an image signal processor (ISP) to obtain the combined image data.

In S30, the combined image data is disassembled to obtain disassembled image data.

In S40, the disassembled image data is visually processed to acquire a visual image.

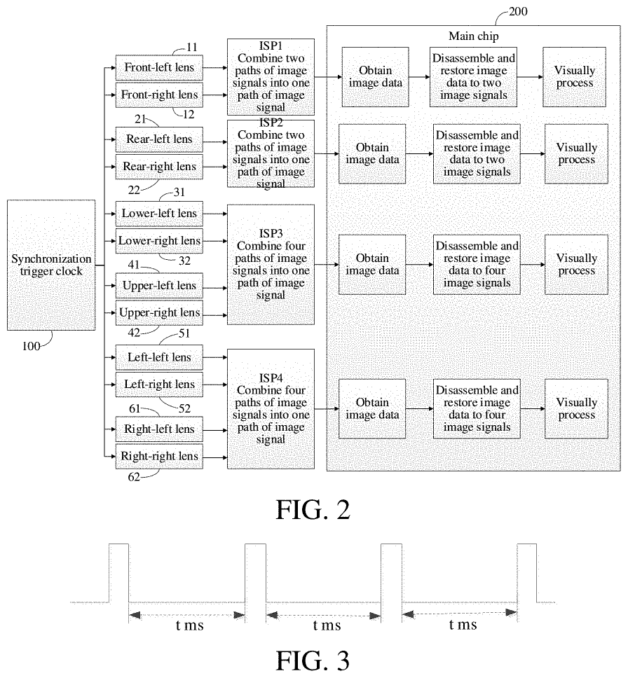

FIG. 2 is a schematic diagram of a system for implementing an omnidirectional vision obstacle avoidance according to an embodiment of the present invention. The system for implementing an omnidirectional vision obstacle avoidance includes a synchronization trigger clock 100, a plurality of ISPs and a main chip 200. The synchronization trigger clock 100 is configured to transmit the trigger signal to the image capture device, to trigger the image capture device to capture image signals. The ISPs are configured to combine the image signals to obtain combined image data. The main chip 200 is configured to disassemble the combined image data and visually process the disassembled image data, to acquire a visual image.

In this embodiment, the image capture device refers to a plurality of lenses of the aircraft in six directions. The six directions include front, rear, upper, lower, left and right directions around the aircraft. There are two lenses in each direction, which are respectively a front-left lens 11, a front-right lens 12, a rear-left lens 21, a rear-right lens 22, a lower-left lens 31, a lower-right lens 32, an upper-left lens 41, an upper-right lens 42, a left-left lens 51, a left-right lens 52, a right-left lens 61 and a right-right lens 62.

FIG. 3 is a schematic diagram of transmitting a trigger signal by a synchronization trigger clock according to an embodiment of the present invention. The synchronization trigger clock periodically transmits the pulse signal once at fixed intervals. As shown in FIG. 3, the pulse signal is transmitted once every t milliseconds (ms), where the t ms is set according to flight speeds and processing speeds of the aircraft. In this embodiment, 10 ms, 40 ms and 100 ms are respectively set and successful tests are performed. The synchronization trigger clock 100 transmits the pulse signal to all the 12 lenses. The 12 lenses are triggered to capture images after receiving the pulse signal, to generate image signals.

The image signals are combined by using the ISP. As shown in FIG. 2, in an embodiment, the system for implementing an omnidirectional vision obstacle avoidance includes four ISPs. The front-left lens 11 and the front-right lens 12 output image signals to ISP1. The rear-left lens 21 and the rear-right lens 22 output image signals to ISP2. The lower-left lens 31, the lower-right lens 32, the upper-left lens 41 and the upper-right lens 42 output image signals to ISP3. The left-left lens 51, the left-right lens 52, the right-left lens 61 and the right-right lens 62 output image signals to ISP4.

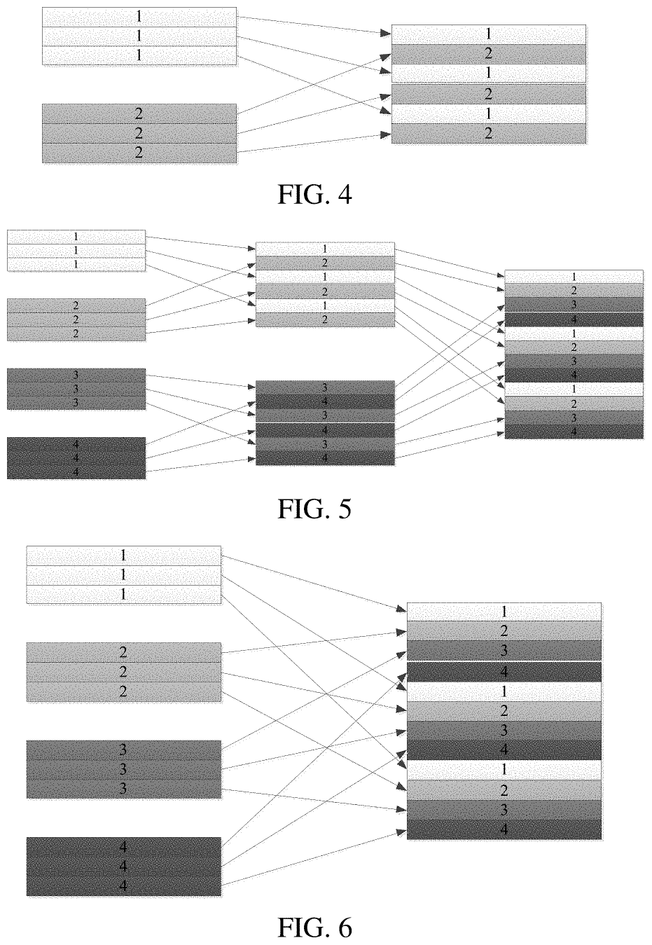

The image signals captured by the plurality of lenses are sequentially combined into image data based on an image line number. FIG. 4 is a schematic diagram of combining two paths of image signals into one path of image signal according to an embodiment of the present invention. A first line of a first image is moved to a first line of a target image, a first line of a second image is moved to a second line of the target image, a second line of the first image is moved to a third line of the target image, a second line of the second image is moved to a fourth line of the target image, a third line of the first image is moved to a fifth line of the target image, a third line of the second image is moved to a sixth line of the target image . . . , so that a new target image is spliced.

Image capture is performed line by line from top to bottom, image lines captured by the lenses may be immediately transmitted to the ISP for combination and cross-combined image lines are immediately transmitted to a back-end for processing. In this manner, there is no need to perform splicing until an image is completely captured, so that a delay time for data processing is reduced and a cache used space is also reduced.

The ISP is further configured to perform image processing. The image processing includes automatic exposure. Automatic exposure parameters of the plurality of lenses are set to be the same and exposure adjustment is automatically performed based on the images processed by the ISP. Left and right lenses on the same side are disposed in the same direction and the image brightness is required to be the same. Therefore, the exposure parameters are the same. Statistical exposure information may be statistical exposure information based on a single left lens or a single right lens or based on combined dual lenses. If the statistical exposure information is based on the left lens, the right lens may automatically perform exposure adjustment with the left lens when an image from the left lens changes. If the statistical exposure information is based on the right lens, the left lens may automatically perform exposure adjustment with the right lens when an image from the right lens changes. If the statistical exposure information is based on combined exposure, the dual lenses simultaneously perform exposure adjustment when an image from any of the single left lens and the single right lens changes or the dual lenses simultaneously perform exposure adjustment when images from both of the dual lens change.

Referring to FIG. 1 again, one frame of image data is simultaneously captured by the lower-left lens 31, the lower-right lens 32, the upper-left lens 41 and the upper-right lens 42 and then is outputted to ISP3 for combination. One frame of image data is simultaneously captured by the left-left lens 51, the left-right lens 52, the right-left lens 61 and the right-right lens 62 and then is outputted to ISP4 for combination.

During combination, four paths of image signals are combined into one path of image signal in the following two manners:

In a first combination method, two paths of image data in four paths of image data are combined into one path of image data, and two other paths of image data in four paths of image data are combined into the other path of image data and then the combined two paths of image are recombined into one combined path of image data. FIG. 5 is a schematic diagram of recombination after two paths of image signals are combined into one path of image signal according to an embodiment of the present invention. After two paths of image signals are combined into one path of image signal twice, image data of the combined image processed by the ISP is outputted to the main chip.

In a second combination method, four paths of image data are directly combined into one path of image data. FIG. 6 is a schematic diagram of directly combining four paths of image signals into one path of image signal according to an embodiment of the present invention.

There are two methods for disassembling the combined image data. In a first method, the combined image data is sequentially copied according to an image line number, to obtain the disassembled image data. In a second method, the combined image data is disassembled according to a start address offset, a width and a stride of the combined image, to obtain the disassembled image data.

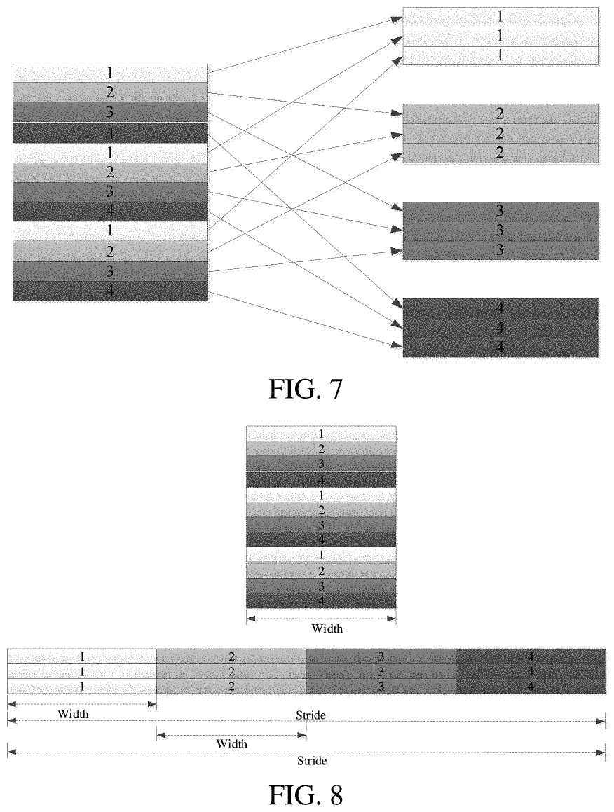

FIG. 7 is a schematic diagram of a first method for disassembling image data according to an embodiment of the present invention. After obtaining the combined image data, the main chip needs to split the combined path of image signals into single path of image signal and then visually processes the image. In a first method, the combined image is split and copied line by line. FIG. 7 shows a process of disassembly and restoration of an image obtained by combining four images. In such a process, a first line of the image is disassembled to a first line of a first target image, a second line is disassembled to a first line of a second target image, a third line is disassembled to a first line of a third target image, a fourth line is disassembled to a first line of a fourth target image, a fifth line is disassembled to a second line of the first target image, a sixth line is disassembled to a second line of the second target image . . . , so that the disassembly and restoration of the image are sequentially performed.

FIG. 8 is a schematic diagram of a second method for disassembling image data according to an embodiment of the present invention. The disassembly and restoration of the image are performed according to the start address offset and the stride of the image. An end address of a first line of the image data in an internal memory is consecutive to a start address of a second line. An end address of the second line is consecutive to a start address of a third line. A start address of a first column of image is set as p1, a width is set as width and a stride is set as stride, namely, stride=width*4. Further, if other three columns of images are considered as blank images in a stride expansion manner, the first column of image is a complete image. A start address of a second column of image is set as p2, a width is set as width and a stride is set as stride, namely, stride=width*4. Further, if other three columns of images are similarly considered as blank images, the second column of image is a complete image. Similarly, the same processing is performed on three and fourth columns of images. Compared with the first method, there is no need to copy any data in the second method and the disassembly and restoration of the image data are implemented through the start address offset and stride expansion. A method for disassembling an image obtained by combining two images is similar to the method for disassembling an image obtained by combining four images.

In addition, the present invention further provides an apparatus for implementing an omnidirectional vision obstacle avoidance.

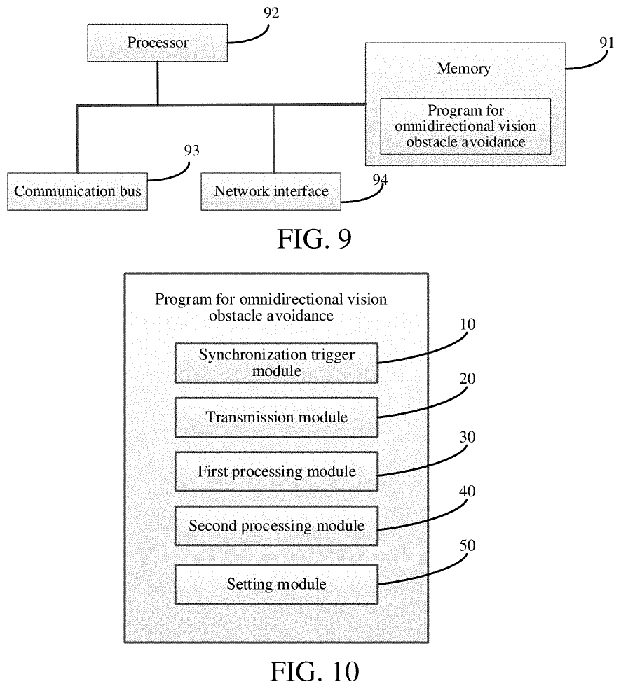

FIG. 9 is a schematic diagram of an internal structure of an apparatus for implementing an omnidirectional vision obstacle avoidance according to an embodiment of the present invention. The apparatus for implementing a multi-lens omnidirectional vision obstacle avoidance in the aircraft includes at least a memory 91, a processor 92, a communication bus 93 and a network interface 94.

The memory 91 includes at least one type of readable storage medium. The readable storage medium includes a flash memory, a hard disk, a multimedia card, a card-type memory (for example, a secure digital (SD) or DX memory), a magnetic memory, a magnetic disk, an optical disk and the like. In some embodiments, the memory 91 may be an internal storage unit of the omnidirectional vision obstacle avoidance implementation apparatus, such as a hard disk of the apparatus for implementing an omnidirectional vision obstacle avoidance. In some other embodiments, the memory 91 may alternatively be an external storage device of the apparatus for implementing an omnidirectional vision obstacle avoidance, such as a plug-in hard disk, a smart media card (SMC), an SD card, or a flash card with which the apparatus for implementing an omnidirectional vision obstacle avoidance is equipped. Further, the memory 91 may include both the internal storage unit and the external storage device of the apparatus for implementing an omnidirectional vision obstacle avoidance. The memory 91 may be configured to store application software installed in the apparatus for implementing an omnidirectional vision obstacle avoidance and various data, such as code of programs for an omnidirectional vision obstacle avoidance and may be further configured to temporarily store data that has been outputted or is about to be outputted.

In some embodiments, the processor 92 may be a central processing unit (CPU), an image signal processor (ISP), a controller, a microcontroller, microprocessor or other data processing chips and is configured to run program code stored in the memory 91 or process data, for example, to execute the programs for omnidirectional vision obstacle avoidance and the like.

The communication bus 93 is configured to implement connection and communication between the components.

The network interface 94 may optionally include a standard wired interface and a wireless interface (for example, a WI-FI interface) and is usually configured to establish a communication connection between the apparatus for implementing an omnidirectional vision obstacle avoidance and other electronic devices.

Optionally, the apparatus for implementing an omnidirectional vision obstacle avoidance may further include a user interface. The user interface may include a display and an input unit such as a keyboard. Optionally, the user interface may further include a standard wired interface and a wireless interface. Optionally, in some embodiments, the display may be a light-emitting diode (LED) display, a liquid crystal display, a touch-sensitive liquid crystal display or an organic light-emitting diode (OLED) touch device. The display may also be appropriately referred to as a display screen or a display unit, which is configured to display information processed in the apparatus for implementing an omnidirectional vision obstacle avoidance and to display a visualized user interface.

FIG. 9 only shows the apparatus for implementing an omnidirectional vision obstacle avoidance with the components 91 to 94 and the program for omnidirectional vision obstacle avoidance. A person skilled in the art may understand that the structure shown in FIG. 9 does not constitute a limitation on the apparatus for implementing an omnidirectional vision obstacle avoidance and may include fewer or more components than those shown in the figure, or some components may be combined or a different component deployment may be used.

In the embodiment of the apparatus for implementing an omnidirectional vision obstacle avoidance shown in FIG. 9, the memory 91 stores the program for omnidirectional vision obstacle avoidance. The processor 92 performs the following steps when executing the program for omnidirectional vision obstacle avoidance stored in the memory 91.

In S10, a trigger signal is transmitted to an image capture device, to trigger the image capture device to capture image signals.

In S20, the image signals are combined to obtain combined image data.

In S30, the combined image data is disassembled to obtain disassembled image data.

In S40, the disassembled image data is visually processed to acquire a visual image.

FIG. 10 is a schematic diagram of modules of a program for omnidirectional vision obstacle avoidance in an apparatus for implementing an omnidirectional vision obstacle avoidance according to an embodiment of the present invention. In this embodiment, the program for omnidirectional vision obstacle avoidance may be divided into a synchronization trigger module 10, a transmission module 20, a first processing module 30, a second processing module 40 and a setting module 50. For example,

the synchronization trigger module 10 is configured to transmit a synchronization trigger pulse signal;

the transmission module 20 is configured to transmit signals and data;

the first processing module 30 is configured for an ISP to perform first processing;

the second processing module 40 is configured for a main chip to perform second processing; and

the setting module 50 is configured to set a synchronization trigger interval time.

Functions or operation steps implemented when program modules such as the synchronization trigger module 10, the transmission module 20, the first processing module 30, the second processing module 40 and the setting module 50 are executed are substantially the same as those described in the above embodiments. Details will not be repeated herein.

In addition, an embodiment of the present invention further provides a storage medium. The storage medium is a computer-readable storage medium and stores a program for omnidirectional vision obstacle avoidance, the program for omnidirectional vision obstacle avoidance being executable by one or more processors performs the following steps.

In S10, a trigger signal is transmitted to an image capture device, to trigger the image capture device to capture image signals.

In S20, the image signals are combined to obtain combined image data.

In S30, the combined image data is disassembled to obtain disassembled image data.

In S40, the disassembled image data is visually processed to acquire a visual image.

A specific implementation of the storage medium in the present invention is substantially the same as embodiments of the above method and apparatus for implementing an omnidirectional vision obstacle avoidance. Details will not be repeated herein.

It should be noted that, the sequence numbers of the embodiments of the present invention are merely for the description purpose but do not imply the preference among the embodiments. In addition, terms “comprise”, “include” or any variation thereof in this specification are intended to cover non-exclusive inclusion. Therefore, a process, an apparatus, an article or a method including a series of elements not only include such elements, but also includes other elements not listed explicitly or includes intrinsic elements for the process, the apparatus, the article, or the method. Unless otherwise specified, an element limited by “include a/an . . . ” does not exclude other same elements existing in the process, the apparatus, the article, or the method including the element.

Through the descriptions of the above implementations, a person skilled in the art may clearly understand that the methods in the above embodiments may be implemented by means of software and a necessary general hardware platform, and certainly, may also be implemented by hardware, but in many cases, the former manner is a better implementation. Based on such understanding, the technical solutions of the present invention essentially, or the part contributing to the prior art, may be presented in the form of a software product. The computer software product is stored in a storage medium as described above (for example, a ROM/RAM, a magnetic disk, or an optical disc) including several instructions to enable a terminal device (which may be an aircraft, a mobile phone, a computer, a server, a network device or the like) to perform the methods described in the embodiments of the present invention.

The above descriptions are merely exemplary embodiments of the present invention and the applied technical principles. A person skilled in the art may understand that the present invention is not limited to the specific embodiments described herein. In addition, various obvious modifications, readjustments and substitutions may be made by a person skilled in the art without departing from the protection scope of the present invention. Therefore, although the present invention is described in detail with reference to the above embodiments, the present invention is not limited to the above embodiments. Further, more other equivalent embodiments without departing from the concept of the present invention may be included and the protection scope of the present invention is subject to the appended claims.

What is claimed is:

1. A method for implementing an omnidirectional vision obstacle avoidance, comprising:
transmitting a trigger signal to an image capture device, to trigger the image capture device to capture image signals;
combining the image signals to obtain combined image data;
disassembling the combined image data to obtain disassembled image data; and
visually processing the disassembled image data to acquire a visual image.

2. The method according to claim 1, wherein the trigger signal is transmitted to the image capture device by using a synchronization trigger clock.

3. The method according to claim 2, wherein the trigger signal is a pulse signal.

4. The method according to claim 1, wherein the combining the image signals to obtain combined image data comprises:
combining the image signals by using an image signal processor (ISP), to obtain the combined image data.

5. The method according to claim 4, wherein capturing the image signals comprises: capturing the image signals line by line, and immediately transmitting the captured image lines to the ISP.

6. The method according to claim 5, wherein combining the image signals to obtain combined image data comprises: cross-combining the image signals by the ISP to obtain combined image data and transmitting the combined image data to a main chip.

7. The method according to claim 1, wherein the disassembling the combined image data comprises:
sequentially copying the combined image data according to an image line number, to obtain the disassembled image data.

8. The method according to claim 1, wherein the disassembling the combined image data comprises:
disassembling the combined image data according to a start address offset, a width and a stride of a combined image, to obtain the disassembled image data.

9. A system for implementing an omnidirectional vision obstacle avoidance, comprising:
a synchronization trigger clock, configured to transmit a trigger signal to an image capture device, to trigger the image capture device to capture image signals;
a plurality of ISPs and a main chip, configured to combine the image signals to obtain combined image data; and
a main chip, configured to disassemble the combined image data and visually process the disassembled image data, to acquire a visual image.

10. The system according to claim 9, wherein the trigger signal is a pulse signal.

11. The system according to claim 9, wherein the image capture device is further configured: capture the image signals line by line, and immediately transmitting the captured image lines to the ISP.

12. The system according to claim 9, wherein the ISP is further configured: cross-combine the image signals by the ISP to obtain combined image data and transmit the combined image data to a main chip.

13. The system according to claim 9, wherein the main chip is further configured to:
sequentially copy the combined image data according to an image line number, to obtain the disassembled image data.

14. The system according to claim 9, wherein the main chip is further configured to:
disassemble the combined image data according to a start address offset, a width and a stride of a combined image, to obtain the disassembled image data.

15. An apparatus for implementing an omnidirectional vision obstacle avoidance, comprising: a memory and a processor, the memory storing a program for an omnidirectional vision obstacle avoidance executable on the processor, the program for the omnidirectional vision obstacle avoidance, when executed by the processor, causing the processor to:
transmit a trigger signal to an image capture device, to trigger the image capture device to capture image signals;
combine the image signals to obtain combined image data;
disassemble the combined image data to obtain disassembled image data; and
visually process the disassembled image data to acquire a visual image.

16. The apparatus according to claim 15, wherein the processor is further configured to combine the image signals by using an image signal processor (ISP), to obtain the combined image data.

17. The apparatus according to claim 16, wherein capturing the image signals comprises: capturing the image signals line by line, and immediately transmitting the captured image lines to the ISP.

18. The apparatus according to claim 17, wherein combining the image signals to obtain combined image data comprises: cross-combining the image signals by the ISP to obtain combined image data and transmitting the combined image data to a main chip.

19. The apparatus according to claim 15, wherein the processor is further configured to:
sequentially copy the combined image data according to an image line number, to obtain the disassembled image data.

20. The apparatus according to claim 15, wherein the processor is further configured to: disassemble the combined image data according to a start address offset, a width and a stride of a combined image, to obtain the disassembled image data.
